(19) United States
(12) Patent Application Publication
(10) Pub. No.: US 2007/0077181 A1
(43) Pub. Date: Apr. 5, 2007

(54) Multiwell plate with modified rib configuration

(76) Inventor: Kathy M. Youngbear, Cambridge, MA (US)

Correspondence Address: Thomas R. Beall, Corning Incorporated, SP-TI-3-1, Corning, NY, 14831, US

(21) Appl. No.: 11/243,895

(22) Filed: Oct. 4, 2005

(51) Int. Cl. B01L 3/00

(52) U.S. Cl. 422/102

(57) ABSTRACT

A multiwell plate utilizing support structures outside a defined analytical zone is disclosed. Resultant plates have the modified structures located on an underside of the multi-well plate permissive to stacking of the plates and also preventing interference with analytical methods.

### FIELD OF INVENTION

The present invention relates generally to microplate assay plates for use in chemical and biochemical analysis, and more particularly multiwell plates having underside structures to assist stacking and alleviate interference with reading equipment.

### BACKGROUND

The recent growth in many areas of biotechnology has increased the demand to perform a variety of studies, commonly referred to as assays, of biochemical systems. These assays include for example, biochemical reaction kinetics, DNA melting point determinations, DNA spectral shifts, DNA and protein concentration measurements, excitation/emission of fluorescent probes, enzyme activities, enzyme co-factor assays, homogeneous assays, drug metabolite assays, drug concentration assays, dispensing confirmation, volume confirmation, solvent concentration, and solvation concentration. Also, there are a number of assays which use intact living cells and which require visual examination.

Assays of biochemical systems are carried out on a large scale in both industry and academia, so it is desirable to have an apparatus that allows these assays to be performed in convenient and inexpensive fashion. Because they are relatively easy to handle, low in cost, and generally disposable after a single use, multiwell plates are often used for such studies. Multiwell plates typically are formed from a polymeric material and consist of an ordered array of individual wells. Each well includes sidewalls and a bottom so that an aliquot of sample may be placed within each well. The wells may be arranged in a matrix of mutually perpendicular rows and columns. Common sizes for multiwell plates include matrices having dimensions of 8×12 (96 wells), 16×24 (384 wells), and 32×48 (1536 wells).

Typically, the materials used to construct a multiwell plate are selected based on the samples to be assayed and the analytical techniques to be used. For example, the materials of which the multiwell plate is made should be chemically inert to the components of the sample or any biological or chemical coating that has been applied to the plate. Further, the materials should be impervious to radiation or heating conditions to which the multiwell plate is exposed during the course of an experiment and should possess a sufficient rigidity for the application at hand.

In many applications, a transparent window in the bottom of each sample well is needed. Transparent bottoms are primarily used in assay techniques that rely on emission of light from a sample and subsequent spectroscopic measurements. Examples of such techniques include liquid scintillation counting, techniques which measure light emitted by luminescent labels, such as bioluminescent or chemoluminescent labels, fluorescent labels, or absorbance levels. Optically transparent bottom wells also lend the advantage of microscopic viewing of specimens and living cells within the well. Currently, optically transparent and ultraviolet transparent bottomed multiwell plates exist in the market and are used to the aforementioned purposes. These microplates are typically made from a hybrid of different polymeric materials, one material making up the sidewalls of the wells and another material making up the bottom walls of the wells.

At present, a series of rib structures on the underside of the microplate serve to facilitate manufacturing, handling and stacking of the plates. The ribs connect the outer skirt portion of the microplate with the array of wells. The ribs provide stability and support for the plate and are key for enabling efficient stacking of successive plates. The ribs along the underside periphery of a standard microplate collectively create a confined area within which the upper surface of a microplate stacked from below may be situated. This confinement is critical in preventing the planar surfaces of successively stacked plates from becoming “nested” upon one another. Plates are said to be nested when the top plate in a successive stack overlaps the bottom plate causing interference. When plates are nested, they can become stuck together and difficult to separate; it is therefore difficult to grasp the top plate without picking up the bottom plate, or any additional plates stacked underneath. Automation systems also discourage such nesting so that each plate in a stack freely release from one another. The standard microplate has a greater clearance distance along its width (between the skirt and nearest row of sample wells) than along its length. As such, there is less room for stacking rib structures to protrude off the skirt along the length of the microplate. Such analytical equipment is designed to interact with a plate from below. The rib structures, particularly those along the length of the plate, can interfere with certain analytical equipment that may require close access to all wells.

For example, one such instrument, Labcyte Echo (versions 550 & 380), dependent on bottom read requires a transducer or lens to transverse the underside of a microplate. The standard placement of the ribs along the length of the microplate interferes with the proper use of equipment, particularly for analysis of the outermost wells adjacent the length portion of the plate. Though manipulation or removal of these ribs is possible, doing so introduces additional encumbrances that hinder the stacking and stability of a microplate placed on a surface. Therefore, there is a need for a microplate design that will allow for efficient plate stacking, while still allowing for ancillary equipment to freely access the undersides of all wells.

### SUMMARY

The present invention offers an improved multiwell plate having a modified series of stabilizing ribs. The multiwell plate for use in assaying samples comprises a frame having a skirt, an array of wells surrounded by the frame, and a plurality of ribs located on an underside of the frame and outside a defined analytical zone.

The rib configuration allows placement of the support structures along the skirt, perpendicular to an outer edge of the frame, preferably in end and/or regions of an underside of the multiwell plate. A microplate/multiwell plate having a notched corner may also accommodate a support structure. Furthermore, when the microplate is utilized with instrumentation that traverses the underside of the microplate, it is preferable to have the rib structures located only in regions along the ends of the microplate unobtrusive to the instrumentation and analytical methods. Additionally, the rib support structures permit multiwell plates to be stacked upon one another without allowing the plates to nest onto each others analytical surfaces. The plurality of ribs creates an x-y plane for another microplate to be stacked beneath an upper microplate. The plurality of ribs can be integral with the frame to provide rigidity and structural support to the microplate, as well as connect the skirt of the frame to the array of wells. The ribs are also capable of creating a constraining x-y surface, or planar surface, so that a plate may be stacked on an underside of microplate, in addition to the upper plate being stably supported. The series of ribs therefore offers an improved structural arrangement that serves to prevent interference with instrumentation during analysis while also affording the benefits of a stackable surface to support a microplate.

### BRIEF DESCRIPTION OF DRAWINGS

FIG. 1A (PRIOR ART) is a standard microplate currently used in the industry.

FIG. 1B (PRIOR ART) illustrates is a perspective underside view of a standard multiwell plate used in industry.

FIG. 1C (PRIOR ART) is a two-dimensional view of the underside of a standard multiwell plate.

FIG. 2A is an underside view of an embodiment of the present invention.

FIG. 2B is a partial cross-sectional side view of two microplates stacked in vertical succession in nominal position.

FIG. 2C is a partial cross-sectional side view of two microplates stacked in succession with the top plate shifted to the left.

### DETAILED DESCRIPTION OF THE INVENTION

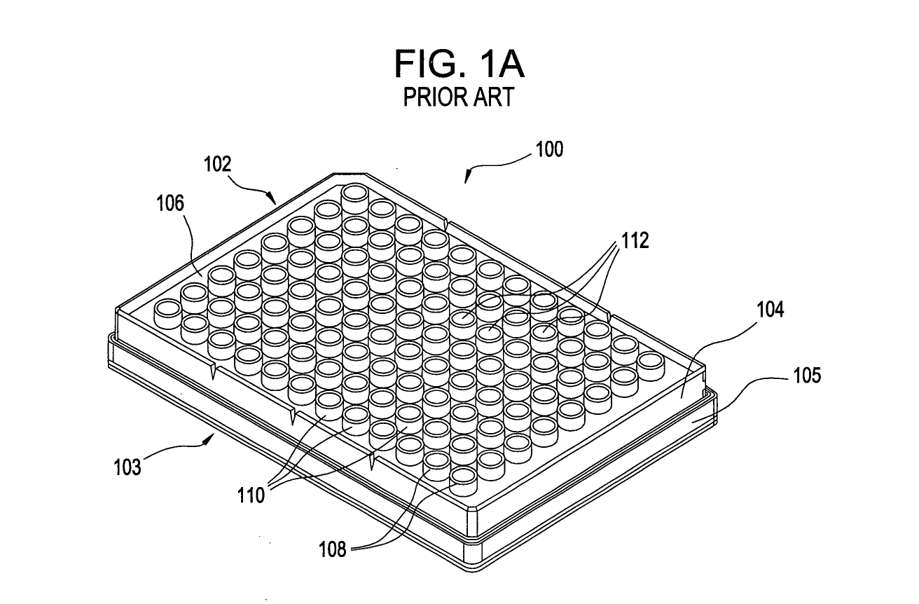

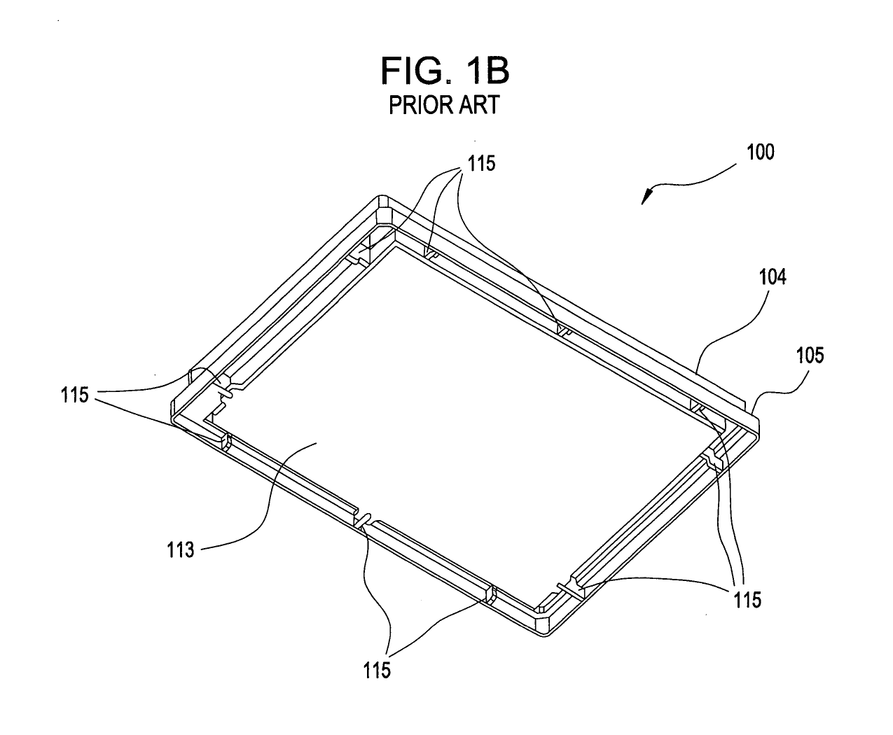

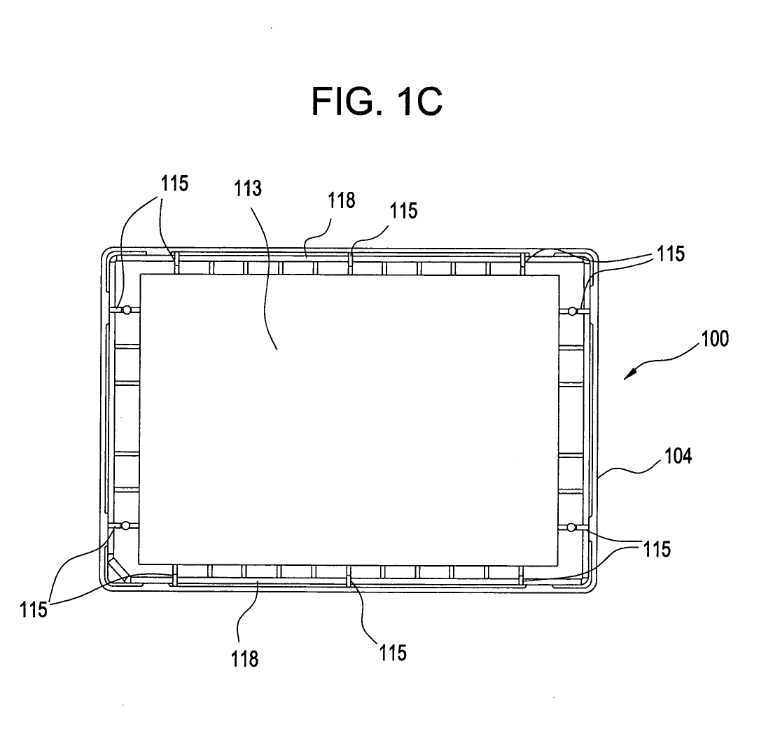

A prior art microplate 100 is shown in FIG. 1 to include an array of wells 1 10 (FIG. 1A) with ends 112 having openings facing upward. The multiwell plate 100 is typically of two-part construction including an upper plate 102 and a lower plate 103. The upper plate 102 includes a frame 104 surrounded by a skirt 105, both peripheral to a top surface 106. Sidewalls 108 delineate the array of wells 110, each well 110 capable of receiving an aliquot of sample to be assayed. The lower plate 103 forms a substantially and preferably flat transparent bottom surface 113 (an underside of which can be seen in FIG. 1B) for each sample well 110. Instrumentation traversing an underside of the microplate 100 has direct access to the array of wells 110. The detector or other analytical equipment can detect activity occurring within the wells 110, or alternatively, on the bottom surface 113 of the well 110. In this embodiment, a corner 146 is notched to facilitate placement into analytical instrumentation mounts. In another embodiment, the plate has a biological sensor or grating/optical configuration located within the bottom 113 of at least some of the wells 110. The lower plate 103, as illustrated, depicts an underside planar surface of the bottom 113 adhered to an underside of the sample wells 110. The surface 113 is internally located within the boundaries of the frame 104 such that the microplate 100 can be read by analytical instrumentation underneath the sample wells 110. Furthermore, rib structures 115 are positioned throughout an underside of the frame skirt 105 causing obstructions with instrumentation on an underside of the microplate 100.

Despite multiple attempts to remove or modify rib structures 115 (spatially depicted in a bottom 2-dimensional view in FIG. 1C), encumbrances still interfere with the underside analytical surface 113 of the microplate 100. Since the ribs 115 are integral with the frame 104 for structural support and standard compliance, removing ribs 115 causes alterations in the rigid structure of the microplate 100. Even modifications to angle the ribs 115 away from underside instrumentation to permit greater access to the underside analytical surface 113 have failed because such modifications adversely affect the stackability of multiple microplates. Additionally, in order to utilize current microplates, underside instrumentation can only traverse the innermost sample surface 113 without interfering with the ribs 115. As such, the outermost wells 110 nearest the frame 104 cannot be included in these analytical methods; only an inner portion of the current sample surface 113 is capable of being utilized, thus restricting effective testing methods.

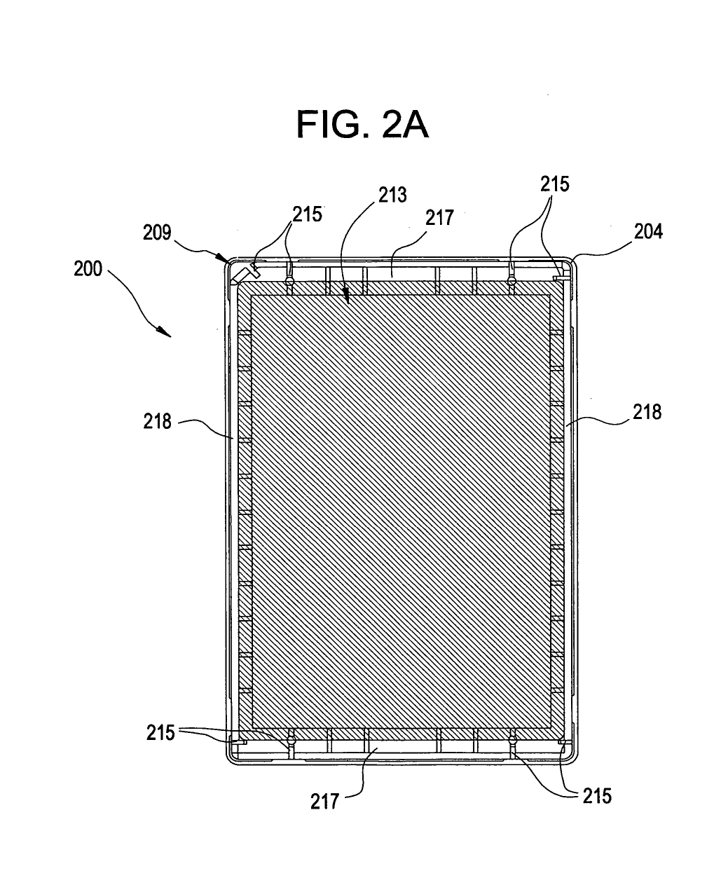

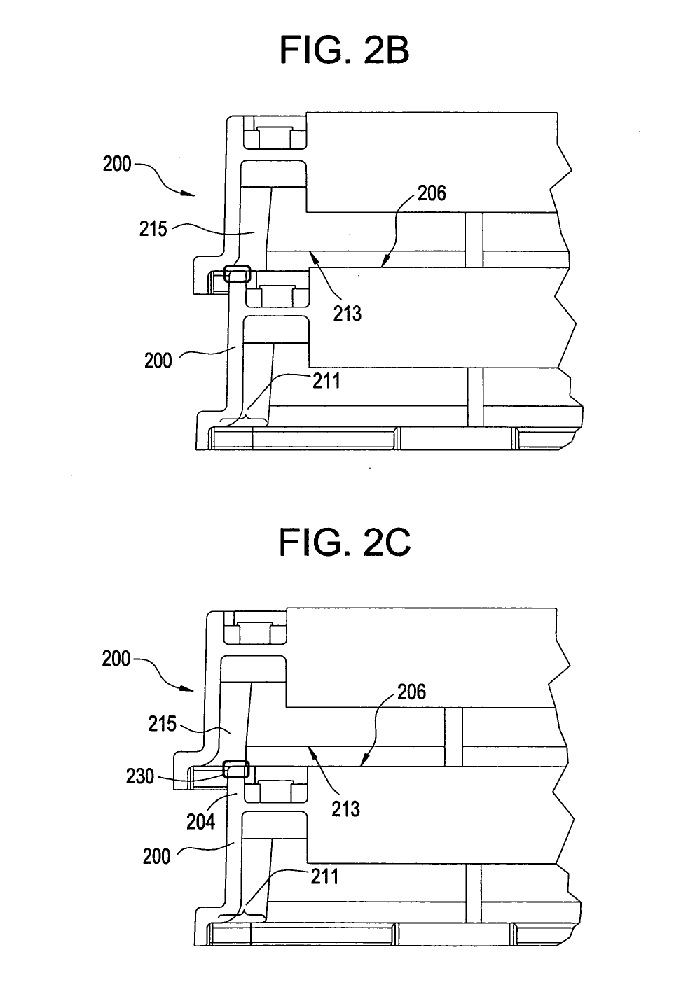

The microplate 200 of the present invention (an underside illustration as seen in FIG. 2) overcomes these previous trials and encumbrances. The microplate 200 has a series of ribs 215 (FIG. 2A) strategically attached or placed on an underside of the frame 204. The placement of the ribs 215 avoids interference with instrumentation traversing an analytical zone 216 (shaded for illustration purposes only), allowing access to even the outermost periphery of wells having a bottom 213 of a multiwell plate 200. The analytical zone 216 is defined as the region where a transducer, lens, or other bottom-read equipment transverses the underside of the microplate 200. Specifically, the ribs 215 are located outside of analytical zone 216, in end regions 217 where there is a greater allotment of space to be utilized in comparison with the limited confines along the underside lengths 218. In respect to standard dimensions of microplates, and in accordance with the 96 well industry standard, the overall height, width, and length dimensions of the multiwell plate 200 are preferably standardized at 14 mm, 85 mm, and 128 mm, respectively. In particular, the standard ribs 115 (FIG. 1) have been removed from the lengths 218. Ribs 215 are now located in regions outside an analytical zone 216 along an end region 217. In this embodiment of the microplate 200, eight ribs 215 are typically used, including one rib 215 located in a notched corner 209. Any number of ribs 215, however, may be utilized in the present invention as long as the ribs to not interfere with the analytical zone 216. The analytical region 216 has therefore been expanded to 3.13 inches width by 4.55 inches length. In comparison with a microplate 100 in the prior art, this expanded analytical region 216 is 0.083 inches greater in width and is no longer limited by standard rib structures. Additionally, the analytical zone 216 now includes the entire surface 213. Furthermore, a transducer can now be utilized for analyses of the entire microplate 200. This improvement over the prior art affords benefits to instrumentation currently necessitated by the industry.

The periphery of the analytical zone 216 is a determined distance from the center of an outermost well in an array of wells. Specifically, the analytical zone 216 for a 1536 well plate, Labcyte Echo compatible, of the present invention preferably has dimensions of about 3.13 inches×4.55 inches; also, Labcyte compatible 384 and 96 well plates preferably have analytical zones 216 with dimensions of about 3.04 in.×4.46 in. and about 2.86 in.×4.28 in., respectively. The 1536 analytical area is therefore the largest (and has previously created the greatest interference with conventional rib structures). Since the nose of a Labcyte transducer is aligned with the center of the outermost well, the distance to the edge or periphery of the analytical zone 216 for a 1536 well plate is about 1.125 mm plus half the diameter of the transducer (3.73 mm), in totality about 4.86 mm. Accordingly, the periphery of the analytical zone 216 is dependent on the dimensions of the individual wells within a well plate; the center of the outermost well of the 1536 well plate is about 1.125 mm outside the center of an outermost well of a 384 well plate, and about 3.375 mm outside the center of an outermost well of a 96 well plate. Subsequently, the improved ribs 215 succeed to permit a transducer to proximally position within less than about 1.50 mm, or more preferably within about 1.10 mm, from the bottom 213 of the wells of the microplate 200 for optimal performance.

The improved ribs 215 of the present invention also permit stable stacking of successive microplates. The ribs 215 further prevent surface 213 from nesting on a surface of a microplate stacked below. FIG. 2B illustrates a cross-section of a microplate 200 having ribs 215 stacked upon another microplate 200. The surface 213 is prevented from nesting onto an upper surface 206 of the bottom stacked microplate 200 when pressure is applied to the upper micoplate 200. Furthermore, the ribs 215 now have a longer base width 211 that was not previously permitted by the restricted area along the lengths 118 of a standard microplate 100. The larger ribs 215 now allow additional support to prevent nesting of the plate surfaces. Instead, the ribs 215 contact an outermost portion of the frame 204 that is peripheral to the upper surface 206. Supplementary, the ribs 215 are permissive to x-y directional shifting (FIG. 2C depicts a top plate shifted to the left; an area 230 emphasized for illustration only) of successive vertically stacked microplates. The ribs 215 create support for vertical stacking of multiple microplates and are capable of confining the microplate 200 in an x and y direction, as well, for a plate stacked just below.

Moreover, the rib structures 215 may be any size and shape to allow stacking of other microplates above and/or below while also preventing interference with instrumentation during analysis of an individual microplate. Furthermore, the ribs 215 may be used alone or in combination with additional features/structures that confine placement of a microplate. Preferably, the plate conforms to industry standards for multiwell plates; that is to say, a plate bordered by a peripheral skirt/frame, laid out with 96 wells in an 8×12 matrix (mutually perpendicular 8 and 12 well rows), 384 or 1536 wells. In particular, the ribs are incorporated with microplates having 1536 wells whose standard underside structural supports previously created interference with a transducer/lens transversing the underside of the microplate. As well, the height, length, and width preferably conform to industry standards. The present invention, however, can be implemented and modified in any type of multiwell plate arrangement including the 96, 384 and/or 1536 well arrays, and is not limited to any specific number of wells or any specific dimensions.

Although the invention has been described in detail for the purpose of illustration, it is understood that such detail is solely for that purpose and variations can be made therein by those skilled in the art without departing from the spirit and scope of the invention which is defined by the following claims.

We claim:

1. A microplate for use in assaying samples, comprising:
a frame having a skirt;
an array of wells surrounded by the frame; and
a plurality of support structures attached to the underside of the skirt and peripheral to the array of wells;
whereby the plurality of support structures prevent interference with the analytical zone.

2. The microplate according to claim 1, the plurality of support structures in combination with the skirt defining an x-y plane for stably stacking one or more microplates.

3. The microplate according to claim 2, the plurality of support structures integral with the frame and connect the skirt to the array.

4. The microplate according to claim 1, wherein the plurality of support structures are ribs constraining the microplate above a second microplate.

5. The multiwell plate according to claim 1, wherein the plurality of support structures are ribs arranged to prevent interference during analysis.
